(19) United States
(12) Patent Application Publication
(10) Pub. No.: US 2018/0334589 A1
(43) Pub. Date: Nov. 22, 2018

(54) HARD COATING RESIN COMPOSITION

(71) Applicant: Korea Institute of Industrial Technology, Cheonan-si (KR)

(72) Inventors: Sang Kug LEE, Yongin-si (KR); Ho Jun Song, Cheonan-si (KR); Ju Hui Kang, Namhae-gun (KR); Jong Tae Leem, Ansan-si (KR)

(21) Appl. No.: 15/979,468

(22) Filed: May 15, 2018

(30) Foreign Application Priority Data
May 16, 2017 (KR) 10-2017-0060567
May 16, 2017 (KR) 10-2017-0060568

(51) Int. Cl. C09D 183/06; C08G 77/14; C08G 77/38; C09D 4/06; C08J 3/24; C08J 7/04

(52) U.S. Cl. CPC C09D 183/06; C08G 77/14; C08G 77/38; C08G 77/70; C08J 3/24; C08J 7/047; C09D 4/06

(57) ABSTRACT

Provided is a hard coating resin composition comprising siloxane with epoxy group, specifically, a hard coating resin composition to form a coating layer having high hardness as well as high flexibility.

### RELATED APPLICATIONS

This application claims the benefit of priority of Korean Patent Application Nos. 10-2017-0060567 and 10-2017-0060568, both filed on May 16, 2017, the contents of which are incorporated herein by reference in their entirety.

### FIELD AND BACKGROUND OF THE INVENTION

The present disclosure relates to a hard coating resin composition comprising siloxane with epoxy group, specifically, a hard coating resin composition to form a coating layer having high hardness as well as high flexibility.

Polymer materials have been used for various purposes in our daily lives. New polymer materials are still being adopted and used regarding workability, mass-production, or cost. As per recent development of multimedia, polymer materials are used in different fields of display, one of which is hard coating sheet to protect display windows. A window of a mobile phone which is exposed to outside should have scratch-resistance, resistance to various solvents, suitable thermal properties for procedures such as deposition, bending, and other processes.

The polymer film for protection of display window used in above-mentioned technical field is utilized in optics and transparent display industry as an essential material, especially as a replacement for glass due to its light weight and workability. However, it has low wear-resistance caused by its lower surface hardness than glass as its disadvantage. With regard to this, high-hardness coating technology, i.e. hard coating technology for improving the surface hardness of polymer film has been an important issue.

The materials used for hard coating can be classified into organic, inorganic, and organic-inorganic composite materials. The organic materials have advantages of high flexibility and high formability and also disadvantages of low surface hardness, and the inorganic materials have high surface hardness and transparency, but low flexibility and formability. Therefore, the organic-inorganic composite materials having advantages of the both materials are now given a lot of attention, a number of researches on which are ongoing, but it has not been achieved to realize all advantages of the two kinds of materials.

For example, Korean patent publication No. 2014-0004568 suggests a siloxane-based hard coating resin composition and producing method thereof. This disclosure achieved high surface hardness. However, there is no description with regard to any improvement of flexibility.

In addition, Korean patent publication No. 2015-0068240 suggests a high-hardness resin composition comprising siloxane with alicyclic epoxy group, a preparation method thereof, and an optical film comprising the cured material thereof. This disclosure also achieved high surface hardness, but the use of single monomer and cationic polymerization initiator can cause weathering problem, and curling phenomena may still arise.

### SUMMARY OF THE INVENTION

An object of the present disclosure is to provide a hard coating resin composition having high flexibility as well as high surface hardness, wherein the composition comprises epoxy-containing siloxane resin having certain range of weight average molecular weight and molecular weight distribution to solve the above-mentioned problems of the prior arts.

Another object of the present disclosure is to provide a hard coating resin composition having high flexibility and high surface hardness, which comprises the epoxy-containing siloxane resin and epoxide-polyhedral oligomeric silsesquioxane compound.

Yet another object of the present disclosure is to provide a hard coating sheet comprising a coating layer produced by curing the hard coating resin composition according to the present invention.

To accomplish the above-mentioned objects, the present disclosure provides a hard coating resin composition comprising epoxy-containing siloxane resin having weight-average molecular weight between 13,000 to 20,000 and molecular weight distribution (PDI; polydispersity) greater than 4.0 and 6.0 or less, and having repeating unit of Chemical Formula 1 below:

R¹ₙSi(OR²)₄₋ₙ [Chemical Formula 1]

where R¹ is a linear or branched C1-C6 alkyl group having an alicyclic epoxy group, and the alicyclic epoxy group is C3-C6 cycloalkyl group having an epoxy-group, R² is a linear or branched C1-C7 alkyl group, and n is an integer of 1 to 3.

The hard coating resin composition according to the present disclosure may further comprise an epoxide-polyhedral oligomeric silsesquioxane (EIPOSS) compound of Chemical Formula 2 below:

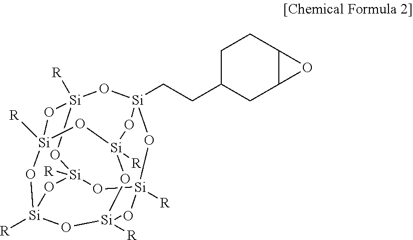

where R is C1-C4 alkyl group.

The hard coating resin composition may comprise 2 to 5 parts by weight of the compound of the Chemical Formula 2 based on 100 parts by weight of the epoxy-containing siloxane resin.

The hard coating resin composition according to the present disclosure may further comprise one or more oxetane-containing monomer.

The amount of the one or more oxetane-containing monomer may be 1 to 40 parts by weight based on 100 parts by weight of the epoxy-containing siloxane resin.

The oxetane-containing monomer may be one or more selected from the group consisting of 3-methyl oxetane, 2-methyl oxetane, 3-oxetanol, 2-methylene oxetane, 3,3-oxetane dimethanethiol, 4-(3-methyl oxetane-3-yl)benzonitrile, N-(2,2-dimethyl propyl)-3-methyl-3-oxetane methanamine, N-(1,2-dimethyl butyl)-3-methyl-3-oxetane methanamine, (3-ethyl oxetan-3-yl)methyl methacrylate, and 4-[(3-ethyl oxetan-3-yl)methoxy]butan-1-ol, 3-ethyl-3-hydroxy methyl oxetane, 2-ethyl hexyl oxetane, xylene bisoxetane, 3-[ethyl-3[[3-ethyloxetan-3-yl]methoxy]methyl]oxetane.

The hard coating resin composition according to the present disclosure may further comprise one or more acid anhydride monomer capable of reacting with the epoxy group of the siloxane resin to form crosslinking.

The acid anhydride monomer may be one or more selected from the group consisting of phthalic anhydride, tetrahydrophthalic anhydride, hexahydrophthalic anhydride, nadic methyl anhydride, chlorendic anhydride, and pyromellitic anhydride.

The hard coating resin composition according to the present disclosure may further comprise one or more additive selected from the group consisting of an organic solvent, a photopolymerization initiator, an antioxidant, a UV-absorbing agent, a hindered-amine light stabilizer, a leveling agent, and a coating facilitating agent.

The present disclosure also provides a hard coating sheet comprising:

a substrate film; and

a coating layer produced by curing the hard coating resin composition according to the present disclosure and disposed on at least one side of the substrate film.

The substrate film may comprise one or more resin selected from the group consisting of acrylic resin, styrene resin, acrylonitrile butadiene styrene resin, styrene acrylonitrile resin, polypropylene resin, polyethylene resin, polyacetal resin, polycarbonate resin, polyamide resin, polyvinylchloride resin, polyester resin, polyurethane resin, norbornene resin, cyclo-olefin resin, epoxy resin, ether sulfone resin.

The curing may performed by photopolymerization.

The surface hardness of the coating layer of the hard coating sheet may have pencil hardness of 8H or higher.

The hard coating sheet may not show occurrence of cracks as a result of the bending test in which the hard coating sheet is bent around a test bar having a bend radius of 1.5-3R so that a coated surface of the coating layer is bent inward repeatedly for 1,500-100,000 times.

The present disclosure also provides a display device comprising the hard coating sheet according to the present disclosure.

The hard coating resin composition according to the present disclosure is capable of forming a coating layer with high flexibility and high surface hardness by comprising epoxy-containing siloxane resin having weight-average molecular weight between 13,000 to 20,000 and molecular weight distribution as PDI (polydispersity) higher than 4.0 and 6.0 or less

In addition, the hard coating resin composition according to the present disclosure is capable of forming a coating layer with high flexibility and high surface hardness by further comprising EIPOSS compound.

### BRIEF DESCRIPTION OF THE SEVERAL VIEWS OF THE DRAWINGS

FIG. 1 is a flow chart showing a process for producing the hard coating sheet according to the Example 1.

FIG. 2 is a flow chart showing a process for producing the hard coating sheet according to the Example 2.

FIG. 3 is ¹H-NMR spectrum chart of epoxy-containing siloxane resins of the Example 1 and Comparative Example 1.

FIGS. 4(A) and 4(b) are photographs showing the bending test FIG. 4(A) of the hard coating sheet according to the Example 1 and the results thereof FIG. 4(B).

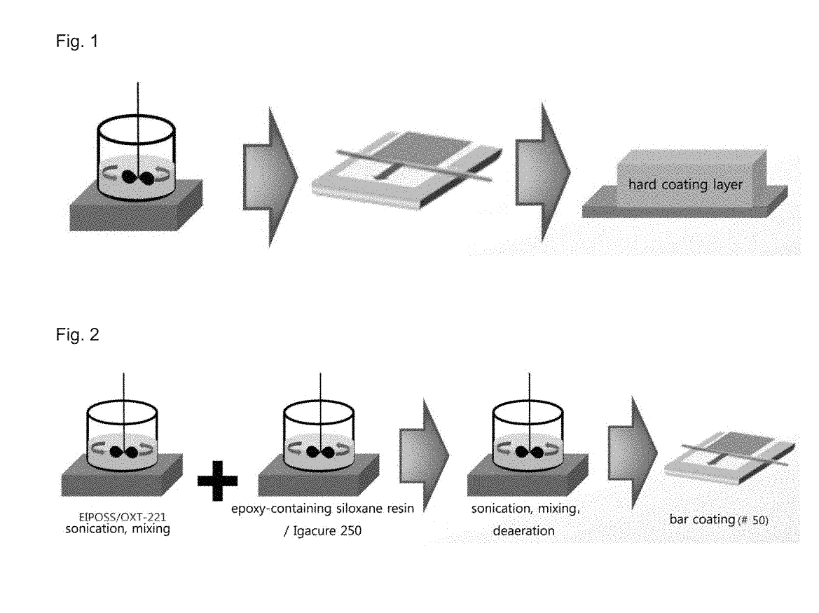

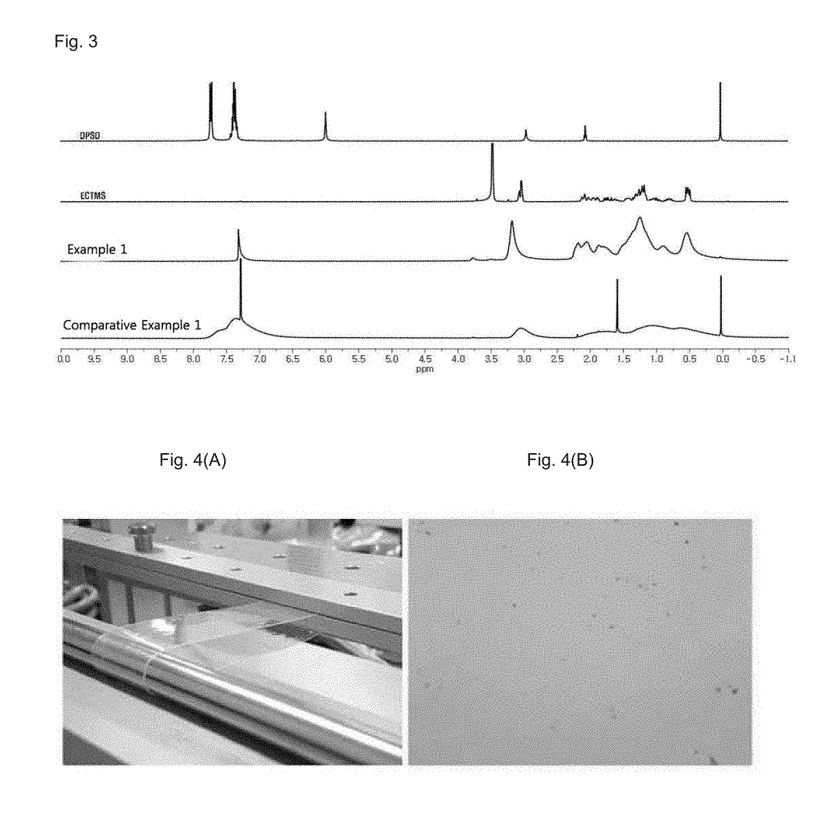

### DESCRIPTION OF SPECIFIC EMBODIMENTS OF THE INVENTION

Various embodiments of present disclosure will now be described more fully with reference to the accompanying drawings in which some embodiments are shown. However, since the invention is not limited to the embodiments disclosed hereinafter, the embodiments of the invention may be implemented in various forms. The embodiments of the invention are only provided for illustrative disclosure of the invention and to fully show the scope of the invention to those skilled in the art, and the present invention is only defined by the scope of the appended claims.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the hard coating resin composition according to the present disclosure will be explained in more detail.

The hard coating resin composition according to the present disclosure may comprise epoxy-containing siloxane resin having weight-average molecular weight between 13,000 to 20,000 and molecular weight distribution as PDI (polydispersity) higher than 4.0 and lower than or same to 6.0, and having repeating unit of Chemical Formula 1 below:

R¹ₙSi(OR²)₄₋ₙ [Chemical Formula 1]

where R¹ is a linear or branched C1˜C6 alkyl group having an alicyclic epoxy group, and the alicyclic epoxy group is C3˜C6 cycloalkyl group having an epoxy-group, R² is a linear or branched C1˜C7 alkyl group, and n is an integer of 1 to 3.

The epoxy-containing siloxane resin (hereinafter, also referred to as ‘epoxy siloxane resin’) is a chemical compound of siloxane molecules having properties of inorganic material and epoxy groups having properties of organic material, and the polymerization method can be depicted as below Reaction Formula.

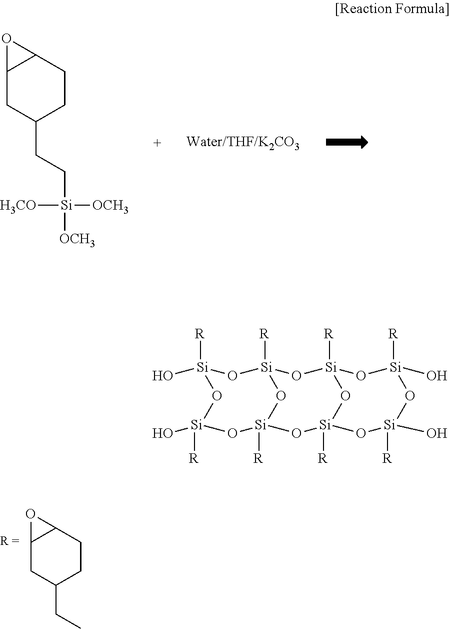

The epoxy siloxane resin has the weight-average molecular weight preferably between 13,000 to 20,000, more preferably between 15,000 to 18,000, and yet more preferably between 15,000 to 17,000, and the molecular weight distribution referred to as PDI (polydispersity) is preferably higher than 4.0 and lower than or same to 6.0, and more preferably between 4.5 to 5.0. It is not desirable that the weight-average molecular weight and the molecular weight distribution are not within the above-mentioned range, where high surface hardness and high flexibility cannot be achieved simultaneously.

The epoxy siloxane resin can be selected from the group consisting of 2-(3,4-epoxycyclohexyl) ethyl trimethoxysilane, 2-(3,4-epoxycyclohexyl) ethyl triethoxysilane, and a combination thereof, but is not limited thereto.

The hard coating resin composition according to the present disclosure may further comprise a compound of Chemical Formula 2 below.

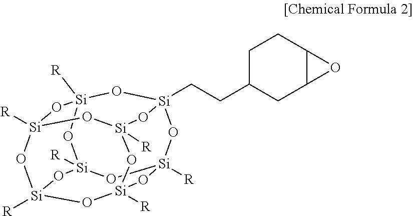

(where R is C1˜C4 alkyl group)

The hard coating resin composition preferably comprises 2 to 5 parts by weight of the compound of the Chemical Formula 2 based on 100 parts by weight of the epoxy siloxane resin, and it is not desirable that the amount is not within the above-mentioned range, where high surface hardness and high flexibility cannot be achieved simultaneously.

The hard coating resin composition according to the present disclosure may further comprise one or more oxetane-containing monomer capable of photopolymerization to control the viscosity of the epoxy siloxane resin and improve the workability.

The addition amount of the oxetane-containing monomer may be, but not limited to, 1 to 40 parts by weight based on 100 parts by weight of the epoxy siloxane resin.

For example, the oxetane-containing monomer may have one or more oxetane group of Chemical Formula 3 below.

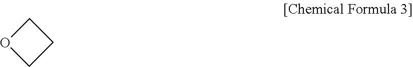

The oxetane-containing monomer may be, but not limited to, one or more selected from the group consisting of 3-methyl oxetane, 2-methyl oxetane, 3-oxetanol, 2-methylene oxetane, 3,3-oxetane dimethanethiol, 4-(3-methyl oxetane-3-yl)benzonitrile, N-(2,2-dimethyl propyl)-3-methyl-3-oxetane methanamine, N-(1,2-dimethyl butyl)-3-methyl-3-oxetane methanamine, (3-ethyl oxetan-3-yl)methyl methacrylate, and 4-[(3-ethyl oxetan-3-yl)methoxy]butan-1-ol, 3-ethyl-3-hydroxy methyl oxetane, 2-ethyl hexyl oxetane, xylene bisoxetane, 3-[ethyl-3[[3-ethyloxetan-3-yl]methoxy]methyl]oxetane.

The hard coating resin composition according to the present disclosure may further comprise one or more acid anhydride monomer capable of reacting with the epoxy group of the epoxy siloxane resin to form crosslinking.

The acid anhydride monomer may be one or more selected from the group consisting of phthalic anhydride, tetrahydrophthalic anhydride, hexahydrophthalic anhydride, nadic methyl anhydride, chlorendic anhydride, and pyromellitic anhydride.

The hard coating resin composition according to the present disclosure may further comprise one or more additive selected from the group consisting of an organic solvent, a photopolymerization initiator, an antioxidant, a UV-absorbing agent, a hindered-amine light stabilizer, a leveling agent, and a coating facilitating agent.

The organic solvent may be one or more selected from the group consisting of ketones such as acetone, methyl ethyl ketone, methyl butyl ketone, methyl isobutyl ketone, cyclohexanone or the like; cellosolves such as methyl cellosolve, ethyl cellosolve, cellosolve acetate, butyl cellosolve or the like; ethers such as ethyl ether, dioxane, tetrahydrobutane or the like; esters such as methyl acetate, ethyl acetate, propyl acetate, isopropyl acetate, butyl acetate, isobutyl acetate, pentyl acetate, isopentyl acetate or the like; alcohols such as butanol, 2-butanol, isobutyl alcohol, isopropyl alcohol or the like; halogenated hydrocarbons such as dichloromethane, chloroform, dichloroethane, trichloroethane, tetrachloroethane, dichloroethylene, trichloroethylene, tetrachloroethylene, chlorobenzene, ortho-dichlorobenzene or the like; hydrocarbons such as n-hexane, cyclohexanol, methyl cyclohexanol, benzene, toluene, xylene or the like; but is not limited thereto.

The addition amount of the organic solvent is preferably 0.1 to 10 parts by weight based on 100 parts by weight of the epoxy siloxane resin, where the viscosity of the epoxy siloxane resin can be controlled so that the final coating film thickness is adjusted while the workability is improved.

The photopolymerization initiator is used for the photopolymerization of the epoxy siloxane resin, and specifically is one or more selected from the group consisting of an onium salt and organic metal salt, but is not limited thereto. The addition amount of the photopolymerization initiator may be, but not limited to, preferably 0.1 to 10 parts by weight based on 100 parts by weight of the epoxy siloxane resin.

The photopolymerization initiator may be one or more selected from the group consisting of an aryl sulfonium hexafluoroantimonate salt, an aryl sulfonium hexafluorophosphate salt, a diphenyl diodonium hexafluorophosphate salt, a diphenyl diodonium hexaantimonium salt, a ditolyl iodonium hexafluorophosphate salt, a 9-(4-hydroxyethoxy phenyl)thianthrenium hexafluorophosphate salt or the like, but is not limited thereto.

The antioxidant may be a mixture of one or more selected from the group consisting of phenolic antioxidants, phosphoric antioxidants, aminic antioxidants, thioester antioxidants or the like, but is not limited thereto. For example, the phenolic antioxidant may be selected from the group consisting of tetrakis[methylene-3-(3,5-di-tert-butyl-4-hydroxyphenyl)propionate]methane, 1,2-bis(3,5-di-tert-butyl-4-hydroxyhydrocinnamoyl)hydrazine, thiodiethylene bis[3-(3,5-di-tert-butyl-4-hydroxyphenyl)propionate], octadecyl-3-(3,5-di-tert-butyl-4-hydroxyphenyl)propionate, isotridecyl-3-(3,5-di-tert-butyl-4-hydroxyphenyl)propionate, N,N′-hexamethylene bis(3,5-di-tert-butyl-4-hydroxyhydrocinnamamide), benzenepropanoic acid, 3,5-bis(1,1-dimethyl ethyl)-4-hydroxy-2,2′-ethylidene bis(4,6-di-tert-butylphenol), 1,3,5-trimethyl-2,4,6-tris(3,5-di-tert-butyl-4-hydroxybenzyl)benzene, 4,6-bis(octyl thiomethyl)-o-cresol, 1,3,5-tris(2,6-dimethyl-3-hydroxy-4-tert-butylbenzyl)isocyanurate, 2,2′-methylenebis(4-methyl-6-tert-butylphenol), triethylene glycol-bis-3-(3-tert-butyl-4-hydroxy-5-methylphenyl)propionate, 2,5-di-tert-amyl-hydroquinone, hexamethylenebis[3-(3,5-di-tert-butyl-4-hydroxyphenyl)propionate], tris-(3,5-di-tert-butyl hydroxybenzyl)isocyanurate, 4,4′-thiobis(6-tert-butyl-m-cresol), 4,4′-butylidene bis(6-tert-3-methylphenol) and combinations thereof; the phosphoric antioxidant may be selected from the group consisting of tris(2,4-di-tert-butyl phenyl)nonyl, distearyl pentaerythritol dinonyl, bis(2,4-di-tert-butyl phenyl)pentaerythritol dinonyl, triphenyl nonyl, triisodecyl nonyl, diphenyl isodecyl nonyl, 2-ethyl hexyl diphenyl nonyl, poly(dipropylene glycol)phenyl nonyl, tris(nonyl phenyl)nonyl and combinations thereof; the aminic antioxidant may be 2,2,4-trimethyl-1,2-dihydroquinoline oligomer; the thioester antioxidant may be selected from the group consisting of pentaerythrityl tetrakis(3-lauryl thiopropionate), distearyl thiodipropionate, dilauryl thiodipropionate, ditridecyl thiodipropionate and combinations thereof, but are not limited thereto.

The addition amount of the antioxidant is not particularly limited, but it is preferably added in an amount of 0.1 to 10 parts by weight, based on 100 parts by weight of the epoxy siloxane resin, where the oxidation reaction caused by the polymerization reaction of epoxy siloxane resin is effectively suppressed.

A hard coating sheet according to the present disclosure may comprise:

a substrate film; and

a coating layer laminated on at least one side of the substrate film, and produced by curing the hard coating resin composition according to the present disclosure.

The substrate film may comprise one or more resin selected from the group consisting of acrylic resin, styrene resin, acrylonitrile butadiene styrene resin, styrene acrylonitrile resin, polypropylene resin, polyethylene resin, polyacetal resin, polycarbonate resin, polyamide resin, polyvinylchloride resin, polyester resin, polyurethane resin, norbornene resin, cyclo-olefin resin, epoxy resin, ether sulfone resin as the main ingredient, but preferably is polyethylene terephthalate.

The coating layer may be formed by being coated using one or more method selected from the group consisting of spin coating, roll coating, spray coating, dip coating, flow coating, doctor blade and dispensing, inkjet printing, offset printing, screen printing, pad printing, gravure printing, flexography printing, stencil printing, imprinting, xerography, lithography, fluidized bed coating, ALD (atomic layer deposition) coating, CVD (chemical vapor deposition), PVD (physical vapor deposition) ion plasma coating, electrostatic coating, and electrodeposition coating and the like, and then cured by photopolymerization using light irradiation. After the light irradiation, thermal treatment may be subsequently performed to obtain the coating layer having homogeneous curing density, and the heat treatment may be performed preferably at a temperature between 50° C. and 250° C., as the polymerization may not occur properly at a temperature lower than 50° C., and the chains between organic functional groups can be broken at a temperature higher than 250° C.

The thickness of the coating layer may be between 20 μm to 60 μm.

The curing may performed by photopolymerization.

The surface hardness of the coating layer of the hard coating sheet may have pencil hardness of 8H or higher.

The hard coating sheet may not show occurrence of cracks as a result of a bending test in which the hard coating sheet is bent around a test bar having a bend radius of 1.5-3R so that a coated surface of the coating layer is bent inward repeatedly for 1,500-100,000 times.

A display device according to the present disclosure may comprise the hard coating sheet according to the present disclosure.

Hereinafter, to demonstrate the superiority of the hard coating resin composition according to the present disclosure, various experiments pertaining to the Examples according to the present disclosure and Comparative Examples, and the results are described.

Methods to Measure Properties and to Evaluate Effects
1) Molecular weight was measured using a Matrix-Assisted Laser Desorption Ionization Mass Spectrometer.
2) Surface hardness was measured using a pencil hardness tester in accordance with JIS K5600.

Flexibility was measured by crack occurrence (◯: no crack; X: cracked) by bending test in which the hard coating sheet is bent around a test bar having a bend radius of 1.5R so that the coated surface is bent inward repeatedly for 100,000 times.
3) as shown in FIG. 4(A).
4) Haze shows the transparency of hard coating sheet, and was measured according to JIS K7105.
5) Light transmittance was measured according to ASTM D1003.

### Example 1

Potassium carbonate (K₂CO₃) 0.01 g, distilled water 1.2 g and tetrahydrofuran (THF) 1.2 g were put into a 1-neck round flask and then stirred at 200 rpm to obtain a mixture. Thereafter, 2-(3,4-epoxycyclohexyl)ethyl trimethoxysilane (ECTMS, product name: SIE4670.0, manufacturer: Gelest) 5.8 g was slowly added to the mixture, and reacted by stirring at 200 rpm at room temperature (25±5° C.) for 5 days under nitrogen atmosphere. After the reaction finished, THF was removed, and the mixture was filtered three times using 300 ml of chloroform and 300 ml of distilled water. Next, moisture was removed from the mixture using magnesium sulfate, chloroform was removed by filtering, and thereby alicyclic epoxy-containing siloxane resin was obtained. The weight-average molecular weight and molecular weight distribution of obtained epoxy siloxane resin are shown in Table 1 below.

The OXT-221 (Tagosei Co., Ltd.) was added to the obtained epoxy siloxane resin at weight ratio of 30:70, 3 wt % of Igacure 250 (manufacturer: Shinyoung Rad Chem) based on the total weight of the final mixture was added, then the mixture was sonicated for 5 minutes, mixed for 5 minutes, deaerated for 2 minutes, and thereby a hard coating resin composition was obtained.

Next, the obtained composition was applied onto the surface of 75 μm-thick polyethylene terephthalate (PET) to have a coating thickness of 30 μm, which was dried on a hot plate at 85° C. for 2 minutes and then exposed under a UV lamp with wavelength of 315 nm for 30 seconds, so as to produce a hard coating sheet. The results of pencil hardness test and bending test for the hard coating sheet were shown in the Table 1 below and FIG. 4(B).

### Comparative Example 1

A hard coating resin composition and a hard coating sheet were produced in the same way with the Example 1, except using epoxy-containing siloxane resin whose weight-average molecular weight and molecular weight distribution were shown in the Table 1 below instead of the epoxy siloxane resin of the Example 1, and the results of pencil hardness test and bending test for the hard coating sheet were integrally shown in the Table 1 below.

### Comparative Example 2

A hard coating resin composition and a hard coating sheet were produced in the same way with the Example 1, except using epoxy-containing siloxane resin whose weight-average molecular weight and molecular weight distribution were shown in the Table 1 below instead of the epoxy siloxane resin of the Example 1, and the results of pencil hardness test bending test for the hard coating sheet were integrally shown in the Table 1 below.

TABLE 1

| | | Comparative | Comparative |
|---|---|---|---|
| | Example 1 | Example 1 | Example 2 |
| weight-average | 16000 | 1771 | 20355 |
| molecular weight | | | |
| molecular weight | 4.6 | 1.18 | 2.31 |
| distribution (PDI) | | | |
| pencil hardness | 8H | 6H | 6H |
| bending test | ∘ | x | x |

As shown in the Table 1 above and FIG. 4(B), the composition of Example 1, whose weight-average molecular weight and molecular weight distribution were within the range of the present disclosure, shows superior properties in pencil hardness and flexibility, but the composition of Comparative Example 1, whose weight-average molecular weight is lower than 13,000 and the molecular weight distribution is below 4, shows lower pencil hardness (6H), and the bending test result is not good either. The composition of Comparative Example 2, whose weight-average molecular weight is higher than 20,000 and molecular weight distribution is below 4, also shows inferior properties in pencil hardness and bending test.

### Example 2

EIPOSS (product name: EP0402, manufacturer: Hybrid Plastics) and OXT-221 (Toagosei Co., Ltd.) was mixed, sonicated for 5 minutes, and stirred for 5 minutes. Then, the epoxy siloxane resin obtained in the Example 1 above and Igacure 250 (manufacturer: Shinyoung Rad Chem) were added, then the mixture was sonicated for 5 minutes, mixed for 5 minutes, deaerated for 2 minutes, and thereby a hard coating resin composition was obtained.

The EIPOSS was added in an amount of 3 parts by weight based on 100 parts by weight of the epoxy siloxane resin, the OXT-221 was added in an amount of 30 parts by weight based on 100 parts by weight of the mixture of the epoxy siloxane resin and the OXT-221, the Igacure 250 was contained in an amount of 3 wt % based on the total weight of the hard coating resin composition.

Next, the obtained composition was applied onto the surface of 75 μm-thick polyethylene terephthalate (PET) to have a coating thickness of 60 μm, which was dried on a hot plate at 85° C. for 2 minutes and then exposed under a UV lamp with wavelength of 315 nm for 30 seconds, so as to produce a hard coating sheet. The results of pencil hardness, bending test, and haze value of the hard coating sheet were shown in the Table 2 below.

### Example 3

A hard coating resin composition and a hard coating sheet were produced in the same way with the Example 2, except adding EIPOSS (product name: EP0402, manufacturer: Hybrid Plastics) in an amount of 5 parts by weight based on 100 parts by weight of the epoxy siloxane resin, and the results of pencil hardness, bending test, and haze value of the hard coating sheet were shown in the Table 2 below.

TABLE 2

| | Example 2 | Example 3 |
|---|---|---|
| Weight-average | 16000 | 16000 |
| molecular weight | | |
| Molecular weight | 4.6 | 4.6 |
| distribution (PDI) | | |
| Pencil hardness | 9H | 9H |
| Bending test | ∘ | ∘ |
| Haze | 1.50 | 3.92 |
| Light transmittance (%) | 90.40 | 90.41 |

As shown in the Table 2 above, the compositions of Example 2 and 3 according to the present disclosure show superior pencil hardness, higher than 9H, and high flexibility.

What is claimed is:

1. A hard coating resin composition comprising epoxy-containing siloxane resin having weight-average molecular weight between 13,000 to 20,000 and molecular weight distribution as PDI (polydispersity) higher than 4.0 and lower than or same to 6.0, and having repeating unit of Chemical Formula 1 below:
R¹ₙSi(OR²)₄₋ₙ [Chemical Formula 1]
where R¹ is linear or branched C1-C6 alkyl group having alicyclic epoxy group, and the alicyclic epoxy group is C3-C6 cycloalkyl group having epoxy group, R² is linear or branched C1-C7 alkyl group, and n is an integer of 1 to 3.

2. The hard coating resin composition according to claim 1, further comprising an epoxide-polyhedral oligomeric silsesquioxane compound of Chemical Formula 2 below: 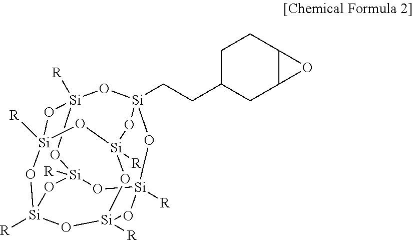
where R is C1-C4 alkyl group.

3. The hard coating resin composition according to claim 2, wherein the amount of the compound of Chemical Formula 2 is 2 to 5 parts by weight based on 100 parts by weight of the epoxy-containing siloxane resin.

4. The hard coating resin composition according to claim 1, further comprising one or more oxetane-containing monomer.

5. The hard coating resin composition according to claim 4, wherein the amount of the one or more oxetane-containing monomer is 1 to 40 parts by weight based on 100 parts by weight of the epoxy-containing siloxane resin.

6. The hard coating resin composition according to claim 5, wherein the oxetane-containing monomer is one or more selected from the group consisting of 3-methyl oxetane, 2-methyl oxetane, 3-oxetanol, 2-methylene oxetane, 3,3-oxetane dimethanethiol, 4-(3-methyl oxetane-3-yl)benzonitrile, N-(2,2-dimethyl propyl)-3-methyl-3-oxetane methanamine, N-(1,2-dimethyl butyl)-3-methyl-3-oxetane methanamine, (3-ethyl oxetan-3-yl)methyl methacrylate, and 4-[(3-ethyl oxetan-3-yl)methoxy]butan-1-ol, 3-ethyl-3-hydroxy methyl oxetane, 2-ethyl hexyl oxetane, xylene bisoxetane, 3-[ethyl-3[[3-ethyloxetan-3-yl]methoxy]methyl]oxetane.

7. The hard coating resin composition according to claim 1, further comprising one or more acid anhydride monomer capable of reacting with the epoxy group of the epoxy-containing siloxane resin to form crosslinking.

8. The hard coating resin composition according to claim 7, wherein the acid anhydride monomer is one or more selected from the group consisting of phthalic anhydride, tetrahydrophthalic anhydride, hexahydrophthalic anhydride, nadic methyl anhydride, chlorendic anhydride, and pyromellitic anhydride.

9. The hard coating resin composition according to claim 1, further comprising one or more additive selected from the group consisting of an organic solvent, a photopolymerization initiator, an antioxidant, a UV-absorbing agent, a hindered-amine light stabilizer, a leveling agent, and a coating facilitating agent.

10. A hard coating sheet comprising:
a substrate film; and
a coating layer produced by curing the hard coating resin composition according to claim 1.

11. The hard coating sheet according to claim 10, wherein the substrate film comprises one or more resin selected from the group consisting of acrylic resin, styrene resin, acrylonitrile butadiene styrene resin, styrene acrylonitrile resin, polypropylene resin, polyethylene resin, polyacetal resin, polycarbonate resin, polyamide resin, polyvinylchloride resin, polyester resin, polyurethane resin, norbornene resin, cyclo-olefin resin, epoxy resin, ether sulfone resin.

12. The hard coating sheet according to claim 10, wherein the curing is performed by photopolymerization.

13. The hard coating sheet according to claim 10, wherein a surface hardness of the coating layer of the hard coating sheet is 8H or higher in pencil hardness.

14. The hard coating sheet according to claim 10, wherein the hard coating sheet does not show occurrence of cracks by the bending test in which the hard coating sheet is bent around a test bar having a bend radius of 1.5-3R so that a coated surface of the coating layer is bent inward repeatedly for 1,500-100,000 times.

15. A display device comprising the hard coating sheet according to claim 10.
